(19) United States
(12) Patent Application Publication
(10) Pub. No.: US 2013/0091035 A1
(43) Pub. Date: Apr. 11, 2013

(54) FAIRNESS BASED RATINGS

(71) Applicants: Kumar Ramana Kota, Santa Clara, CA (US); Pradeep Akkinepally, Milpitas, CA (US); Srikrishna Gopalakrishnan, San Jose, CA (US)

(72) Inventors: Kumar Ramana Kota, Santa Clara, CA (US); Pradeep Akkinepally, Milpitas, CA (US); Srikrishna Gopalakrishnan, San Jose, CA (US)

(73) Assignee: eBay Inc., San Jose, CA (US)

(21) Appl. No.: 13/253,518

(22) Filed: Oct. 5, 2011

(51) Int. Cl. G06Q 30/00

(52) U.S. Cl. 705/26.35

(57) ABSTRACT

An apparatus and method for identifying and correcting “unfair” ratings about a first user from a plurality of second users is disclosed herein. For each metric upon which the first user has been rated by the second users, a number of factors are considered to determine if the average rating for a given metric is unfair. Identified unfairness is adjusted dynamically so that the composite rating for a metric becomes more “fair.”

### TECHNICAL FIELD

The present application relates generally to systems and methods for generating ratings, and in one specific example to systems and methods for generating composite ratings from a plurality of users.

### BACKGROUND

The rise of the Internet spawned a variety of enterprises including, but not limited to, electronic commerce, blogging, social media, recommendation systems, online gaming, and the like. One of the reoccurring themes with online-based environments is the prevalence and value of input from a plurality of users. User input could be about a particular transaction (e.g., a product or service purchase), entity (e.g., a seller or store), product or service, content posted on a web page, event, or other aspects pertaining to a particular online-based environment. Depending on the context in which the user input is provided, it may be referred to as feedback, reviews, ratings, opinion, testimonials, commentary, knowledge sharing, or the like. User input may be solicited or provided voluntarily.

User input, especially input from a plurality of users, is valuable to a website on which the user input is posted and for viewers of the website, who may be buyers, sellers, manufacturers, or others who may gain from the posted content. Among other things, user input conveys insight and experiences of a plurality of users about a particular place, person, or thing. Even the users themselves that provide input may benefit from the opportunity to share their opinions. They may have no ulterior motive other than to share information with the community at large.

For example, in an electronic commerce marketplace, buyers may provide feedback about sellers from whom they made purchases. The feedback can be quantitative rating about the seller on one or more metrics. Such feedback allows future buyers to gauge the trustworthiness of a seller (or other metric that is important to the buyer) relative to other sellers in the same marketplace. Unfortunately, a small subset of feedbacks may have a disproportionate impact on the overall rating of a seller. For example, this could happen if there are only a few feedbacks for a seller, a small subset of feedback differs significantly from the rest of the feedback for a seller, or certain buyers intentionally provide false feedback. Under any of these situations and using standard aggregation techniques, the seller may be unfairly rated overall.

### BRIEF DESCRIPTION OF THE DRAWINGS

Some embodiments are illustrated by way of example and not limitation in the figures of the accompanying drawings.

FIG. 1 illustrates a network diagram depicting an exemplary client-server system according to some embodiments.

FIG. 2 illustrates a block diagram of additional details of applications included in the client-server system of FIG. 1.

FIG. 3 illustrates a block diagram showing modules included in reputation applications of the client-server system of FIG. 1.

FIGS. 4A-4B illustrate a flow diagram for generating fairness based ratings according to some embodiments.

FIG. 5 illustrates a detailed flow diagram of a portion of the flow diagram of FIG. 4A.

FIG. 6 shows a diagrammatic representation of a machine in the example form of a computer system within which a set of instructions, for causing the machine to perform any one or more of the methodologies discussed herein, may be executed.

The headings provided herein are for convenience only and do not necessarily affect the scope or meaning of the claimed invention.

### DETAILED DESCRIPTION

Described in detail below is an apparatus and method for identifying and correcting “unfair” ratings about one or more first users from a plurality of second users. For each metric upon which a first user has been rated by one or more of the second users, a number of factors are considered to determine if an average rating for a given metric is “unfair.” Unfairness may arise, among other things, if low ratings from a very small number of second users disproportionately skew the composite rating for a metric. Identified unfairness is adjusted so that the composite rating for a metric is made more “fair.” Once every individual metrics for the first user have been evaluated, an overall rating for the first user is determined from the individual metric levels.

The following description is presented to enable any person skilled in the art to create and use a computer system configuration and related method and article of manufacture to automatically evaluate negative evaluations from a second plurality of users about a first plurality of users and dynamically adjust for skewing negative evaluations in overall evaluations. Various modifications to the example embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the art will realize that the invention may be practiced without the use of these specific details. In other instances, well-known structures and processes are shown in block diagram form in order not to obscure the description of the invention with unnecessary detail. Thus, the present invention is not intended to be limited to the embodiments shown, but is to be accorded the widest scope consistent with the principles and features disclosed herein.

There are many instances in which one person (a rater) provides a feedback, evaluation, review, rating, opinion, testimonial, commentary, or other expression (collectively referred to as a rating) about another person, place, item, or transaction (collectively a ratee). Such information may be solicited or voluntarily provided. When a number of such information is provided about a ratee, it can be aggregated and posted. When repeated for a plurality of ratees, such ratings provide a simple way to compare one ratee relative to another ratee. Depending on the amount of information and a degree of granularity of information desired to be collected about each ratee, a rater may be asked to quantitatively rate a ratee on each of one or more metrics.

For example, in the case of the rater being a buyer and the ratee being a seller in a commerce or marketplace setting, the buyer may be asked to rate the seller's performance pertaining to the buyer's experience in purchasing a product or service from the seller (e.g., the buyer rating a particular transaction with the seller). The seller's performance can be broken down into metrics such as, but not limited to, how well the item was described, communication with the seller during the transaction, amount of time it took to receive the purchased item, cost to have to the item shipped, whether an issue with the transaction was resolved by the seller, and the like.

When transactions between buyers and sellers take place in an electronic commerce or marketplace system, buyers' ratings may also be captured and presented by the same system. Presentation within the same system provides timely information to prospective buyers for future transactions. Although an example pertaining to buyers, sellers, and ratings pertaining to purchases of products or services in an electronic commerce/marketplace setting is described herein, it should be understood that the invention is not so limited. Rather, embodiments of the invention are applicable to other contexts in which a rater rates a ratee for whatever reason, and the ratings are quantifiable such that static and/or dynamic “unfairness” can be assessed and addressed, as necessary. Example applicability of embodiments of the invention include, but are not limited to, product or service reviews, ratings of individuals (e.g., professional services), Internet-based voting (including negative voting of ideas, thoughts and other non-physical goods), and the like.

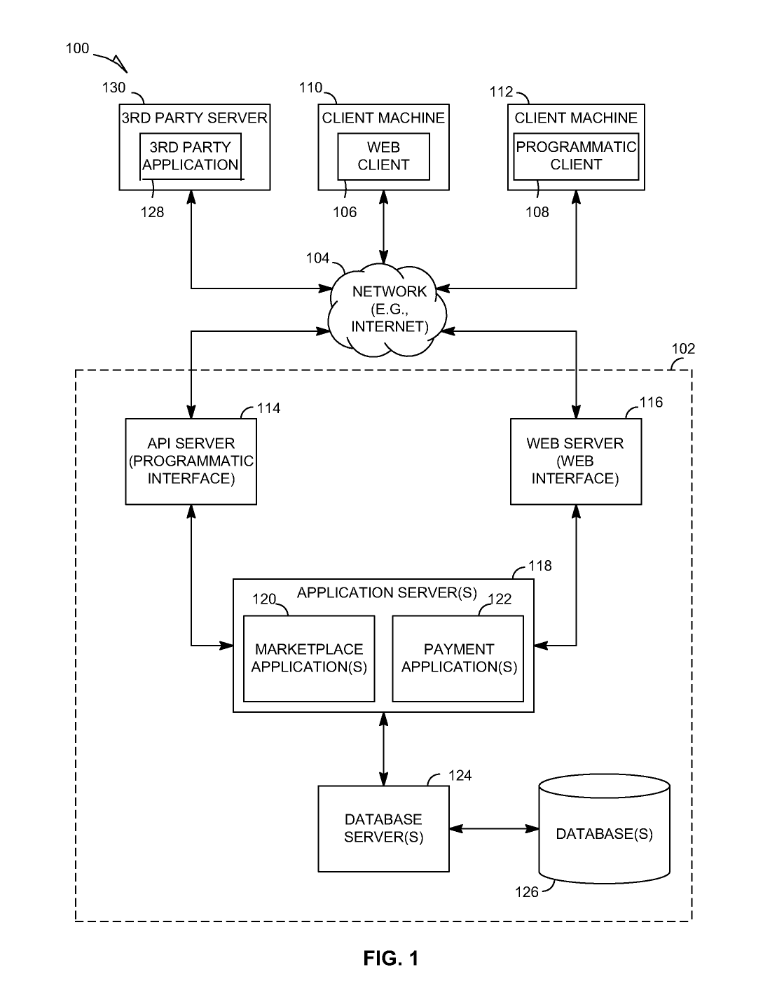

FIG. 1 illustrates a network diagram depicting an exemplary client-server system 100 for providing fairness based ratings according to some embodiments. A networked system 102, in the example forms a network-based publication system that provides server-side functionality, via a network 104 (e.g., the Internet or Wide Area Network (WAN)) to one or more clients. FIG. 1 further illustrates, for example, a web client 106 (e.g., a browser, such as the Internet Explorer browser developed by Microsoft Corporation of Redmond, Wash.), and a programmatic client 108 executing on respective client machines 110 and 112. In one embodiment, the publication system comprises a marketplace system. In another embodiment, the publication system comprises other types of systems such as, but not limited to, a social networking system, an information retrieval system, and the like.

An Application Program Interface (API) server 114 and a web server 116 are coupled to, and provide programmatic and web interfaces respectively to, one or more application servers 118. The application servers 118 host one or more marketplace applications 120 and payment applications 122. The application servers 118 are, in turn, shown to be coupled to one or more databases servers 124 that facilitate access to one or more databases 126.

The marketplace applications 120 may provide a number of marketplace functions and services to users that access networked system 102. The payment applications 122 may likewise provide a number of payment services and functions to users. The payment applications 122 may allow users to accumulate value (e.g., in a commercial currency, such as the U.S. dollar, or a proprietary currency, such as “points”) in accounts, and then later to redeem the accumulated value for products (e.g., goods or services) that are made available via the marketplace applications 120. While the marketplace and payment applications 120 and 122 are shown in FIG. 1 to both form part of the networked system 102, it will be appreciated that, in alternative embodiments, the payment applications 122 may form part of a payment service that is separate and distinct from the networked system 102.

Further, while the system 100 shown in FIG. 1 employs a client-server architecture, the present invention is of course not limited to such an architecture, and could equally well find application in a distributed, or peer-to-peer, architecture system, for example. The various marketplace and payment applications 120 and 122 could also be implemented as standalone software programs, which do not necessarily have networking capabilities.

The web client 106 accesses the various marketplace and payment applications 120 and 122 via the web interface supported by the web server 116. Similarly, the programmatic client 108 accesses the various services and functions provided by the marketplace and payment applications 120 and 122 via the programmatic interface provided by the API server 114. The programmatic client 108 may, for example, be a seller application (e.g., the TurboLister application developed by eBay Inc., of San Jose, Calif.) to enable sellers to author and manage listings on the networked system 102 in an off-line manner, and to perform batch-mode communications between the programmatic client 108 and the networked system 102.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more promotional, marketplace, or payment functions that are supported by the relevant applications of the networked system 102.

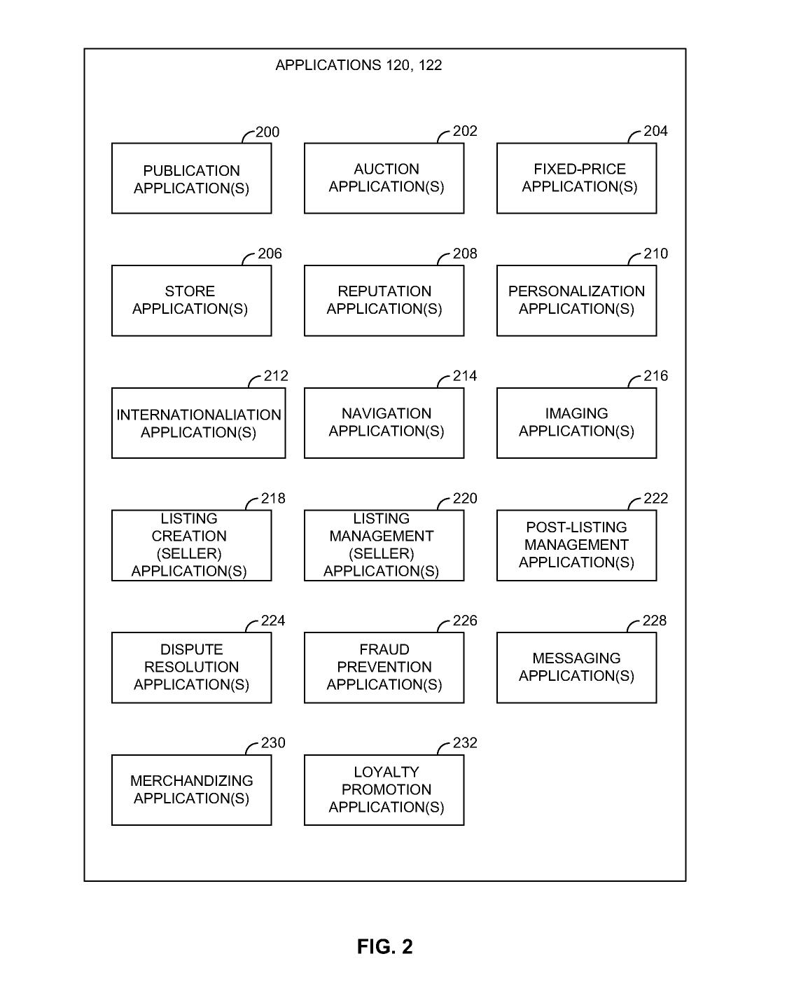

FIG. 2 illustrates a block diagram of additional details of applications 120 and 122 according to some embodiments. Applications 120 and 122 may be hosted on dedicated or shared server machines (not shown) that are communicatively coupled to enable communications between server machines. The applications themselves are communicatively coupled (e.g., via appropriate interfaces) to each other and to various data sources, so as to follow information to be passed between the applications or so as to allow the applications to share and access common data. The applications may furthermore access one or more databases 126 via the data servers 128.

Networked system 102 may provide a number of publishing, listing and price-setting mechanisms whereby a seller may list (or publish information concerning) goods or services for sale, a buyer can express interest in or indicate a desire to purchase such goods or services, and a price can be set for a transaction pertaining to the goods or services. To this end, the marketplace applications 120 are shown to include at least one publication application 200 and one or more auction applications 202 which support auction-format listing and price setting mechanisms (e.g., English, Dutch, Vickrey, Chinese, Double, reverse auctions, etc.). The various auction applications 202 may also provide a number of features in support of such auction-format listings, such as a reserve price feature whereby a seller may specify a reserve price in connection with a listing and a proxy-bidding feature whereby a bidder may invoke automated proxy bidding.

A number of fixed-price applications 204 support fixed-price listing formats (e.g., the traditional classified advertisement-type listing or a catalogue listing) and buyout-type listings. Specifically, buyout-type listings (e.g., including the Buy-It-Now (BIN) technology developed by eBay Inc., of San Jose, Calif.) may be offered in conjunction with auction-format listings, and allow a buyer to purchase goods or services, which are also being offered for sale via an auction, for a fixed-price that is typically higher than the starting price of the auction.

Store applications 206 allow a seller to group listings within a “virtual” store, which may be branded and otherwise personalized by and for the seller. Such a virtual store may also offer promotions, incentives and features that are specific and personalized to a relevant seller.

Reputation applications 208 allow users that transact, utilizing the networked system 102, to establish, build and maintain reputations, which may be made available and published to potential trading partners. Consider that where, for example, the networked system 102 supports person-to-person trading, users may otherwise have no history or other reference information whereby the trustworthiness and credibility of potential trading partners may be assessed. The reputation applications 208 allow a user, for example through feedback provided by other transaction partners, to establish a reputation within the networked system 102 over time. Other potential trading partners may then reference such a reputation for the purposes of assessing credibility and trustworthiness.

Personalization applications 210 allow users of the networked system 102 to personalize various aspects of their interactions with the networked system 102. For example a user may, utilizing an appropriate personalization application 210, create a personalized reference page at which information regarding transactions to which the user is (or has been) a party may be viewed. Further, a personalization application 210 may enable a user to personalize listings and other aspects of their interactions with the networked system 102 and other parties.

The networked system 102 may support a number of marketplaces that are customized, for example, for specific geographic regions. A version of the networked system 102 may be customized for the United Kingdom, whereas another version of the networked system 102 may be customized for the United States. Each of these versions may operate as an independent marketplace, or may be customized (or internationalized) presentations of a common underlying marketplace. The networked system 102 may accordingly include a number of internationalization applications 212 that customize information (and/or the presentation of information) by the networked system 102 according to predetermined criteria (e.g., geographic, demographic or marketplace criteria). For example, the internationalization applications 212 may be used to support the customization of information for a number of regional websites that are operated by the networked system 102 and that are accessible via respective web servers 116.

Navigation of the networked system 102 may be facilitated by one or more navigation applications 214. For example, a search application (as an example of a navigation application) may enable key word searches of listings published via the networked system 102. A browse application may allow users to browse various category, catalogue, or inventory data structures according to which listings may be classified within the networked system 102. Various other navigation applications may be provided to supplement the search and browsing applications.

In order to make listings, available via the networked system 102, as visually informing and attractive as possible, the marketplace applications 120 may include one or more imaging applications 216 utilizing which users may upload images for inclusion within listings. An imaging application 216 also operates to incorporate images within viewed listings. The imaging applications 216 may also support one or more promotional features, such as image galleries that are presented to potential buyers. For example, sellers may pay an additional fee to have an image included within a gallery of images for promoted items.

Listing creation applications 218 allow sellers conveniently to author listings pertaining to goods or services that they wish to transact via the networked system 102, and listing management applications 220 allow sellers to manage such listings. Specifically, where a particular seller has authored and/or published a large number of listings, the management of such listings may present a challenge. The listing management applications 220 provide a number of features (e.g., auto-relisting, inventory level monitors, etc.) to assist the seller in managing such listings. One or more post-listing management applications 222 also assist sellers with a number of activities that typically occurs post-listing. For example, upon completion of an auction facilitated by one or more auction applications 202, a seller may wish to leave feedback regarding a particular buyer. To this end, a post-listing management application 222 may provide an interface to one or more reputation applications 208, so as to allow the seller conveniently to provide feedback regarding multiple buyers to the reputation applications 208.

Dispute resolution applications 224 provide mechanisms whereby disputes arising between transacting parties may be resolved. For example, the dispute resolution applications 224 may provide guided procedures whereby the parties are guided through a number of steps in an attempt to settle a dispute. In the event that the dispute cannot be settled via the guided procedures, the dispute may be escalated to a third party mediator or arbitrator.

A number of fraud prevention applications 226 implement fraud detection and prevention mechanisms to reduce the occurrence of fraud within the networked system 102.

Messaging applications 228 are responsible for the generation and delivery of messages to users of the networked system 102, such messages for example advising users regarding the status of listings at the networked system 102 (e.g., providing “outbid” notices to bidders during an auction process or to provide promotional and merchandising information to users). Respective messaging applications 228 may utilize any one of a number of message delivery networks and platforms to deliver messages to users. For example, messaging applications 228 may deliver electronic mail (e-mail), instant message (IM), Short Message Service (SMS), text, facsimile, or voice (e.g., Voice over IP (VoIP)) messages via the wired (e.g., the Internet), Plain Old Telephone Service (POTS), or wireless (e.g., mobile, cellular, WiFi, WiMAX) networks.

Merchandising applications 230 support various merchandising functions that are made available to sellers to enable sellers to increase sales via the networked system 102. The merchandising applications 230 also operate the various merchandising features that may be invoked by sellers, and may monitor and track the success of merchandising strategies employed by sellers.

The networked system 102 itself, or one or more parties that transact via the networked system 102, may operate loyalty programs that are supported by one or more loyalty/promotions applications 232. For example, a buyer may earn loyalty or promotions points for each transaction established and/or concluded with a particular seller, and may be offered a reward for which accumulated loyalty points can be redeemed.

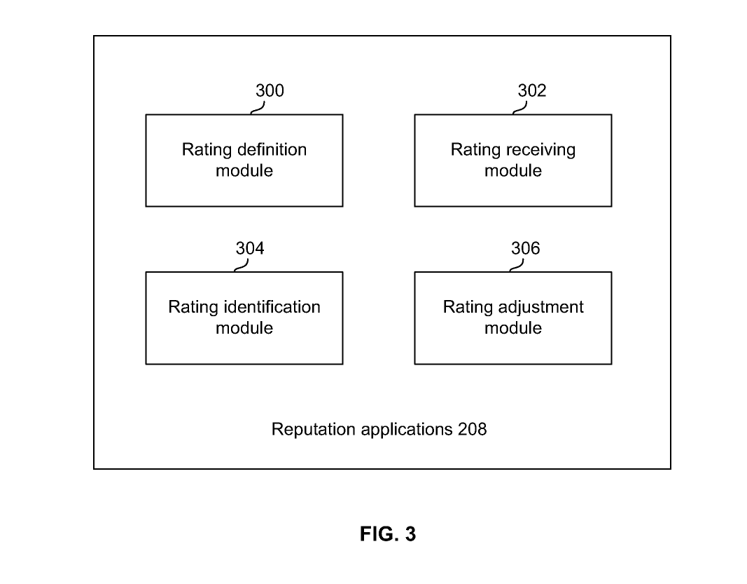

FIG. 3 illustrates a block diagram showing modules included in the reputation applications 208 according to some embodiments. The reputation applications 208 include a rating definition module 300, a rating receiving module 302, a rating identification module 304, and a rating adjustment module 306. Although modules 300-306 are shown as distinct modules in FIG. 3, it should be understood that modules 300-306 may be implemented as fewer or more modules than illustrated. It should also be understood that any of modules 300-306 may communicate with one or more components included in networked system 102, such as database servers 124, API server 114, or web server 116. Modules 300-306 represent conceptual modules that cause one or more processors, computers, or machines to perform certain tasks as described herein.

In the rating definition module 300, parameters pertaining to receiving quantitative ratings from users are defined. Parameters include specifying the different metrics on which users will be rated, a range of possible rating values, and the like. For example, a user (e.g., a seller) may be evaluated on six different metrics: how well an item was described, communication with the seller, shipping time, shipping cost, open cases (e.g., complaints), and closed cases without seller resolution. For each of these metrics, the user may be given a rating of between a value of one to five, in which one is the lowest and five is the highest. In alterative examples, there may be fewer or more metrics or different metrics defined, and/or a different rating scale may be used. The decision of particular metrics and ratings scale are mere implementation details depending on the feedback information desired or preferred information to share with future users of the system. In other embodiments, qualitative ratings may be converted into quantitative ratings by the system 102 in order to apply fairness rating described herein.

Once rating parameters have been defined, the rating receiving module 302 interacts with a first plurality of users (e.g., buyers) to obtain ratings from the first plurality of users about a second plurality of users (e.g., sellers). Continuing the example, each time a buyer purchases a product or service offered by a seller, the rating receiving module 302 requests the buyer to rate the transaction and seller's performance regarding the transaction. The buyer rates the seller between a scale of, for example, one to five on each of the following metrics: item description, communication, shipping time, and shipping cost. Open cases and closed cases without resolution metrics may be assigned ratings over time rather than for every transaction because these metrics may not be applicable for every transaction. For example, when a buyer is unhappy with a particular transaction, he or she can open a case against the seller. This counts as an open case against the seller. Conversely, when the buyer does not open a case against the seller, this does not count against the seller. As another example, the case opened against the seller may be resolved by the seller within a prescribed time period (which is positively viewed for rating purposes). However, if the seller does not revolve the open case within the prescribed time period, the case is closed without seller resolution. Such case closure is counted against the seller.

User input of ratings for one or more metrics can come from outside the reputation applications 208. For example, the open cases metric or the closed cases without resolution metrics may be evaluated based on user input provided through telephonic, electronic mail, or other input mechanism other than an input interface provided by the rating receiving module 302. Embodiments of the invention contemplates any number of ways of capturing user ratings and subsequent pre-processing that may be required to apply a fairness adjustment.

The rating receiving module 302 and rating identification module 304 work in conjunction to capture and ready the user ratings for use by the rating adjustment module 306. The rating identification module 304 is configured to collate and associate identifier information to the generated ratings for later use. For example, each generated rating may be associated with a buyer identifier, a seller identifier, metric, transaction identifier, and/or date/time stamp. The ratings and associated identifier information may be stored in databases 126. Such information permits the rating adjustment module 306 to perform ratings adjustments, as necessary, to provide a fair rating.

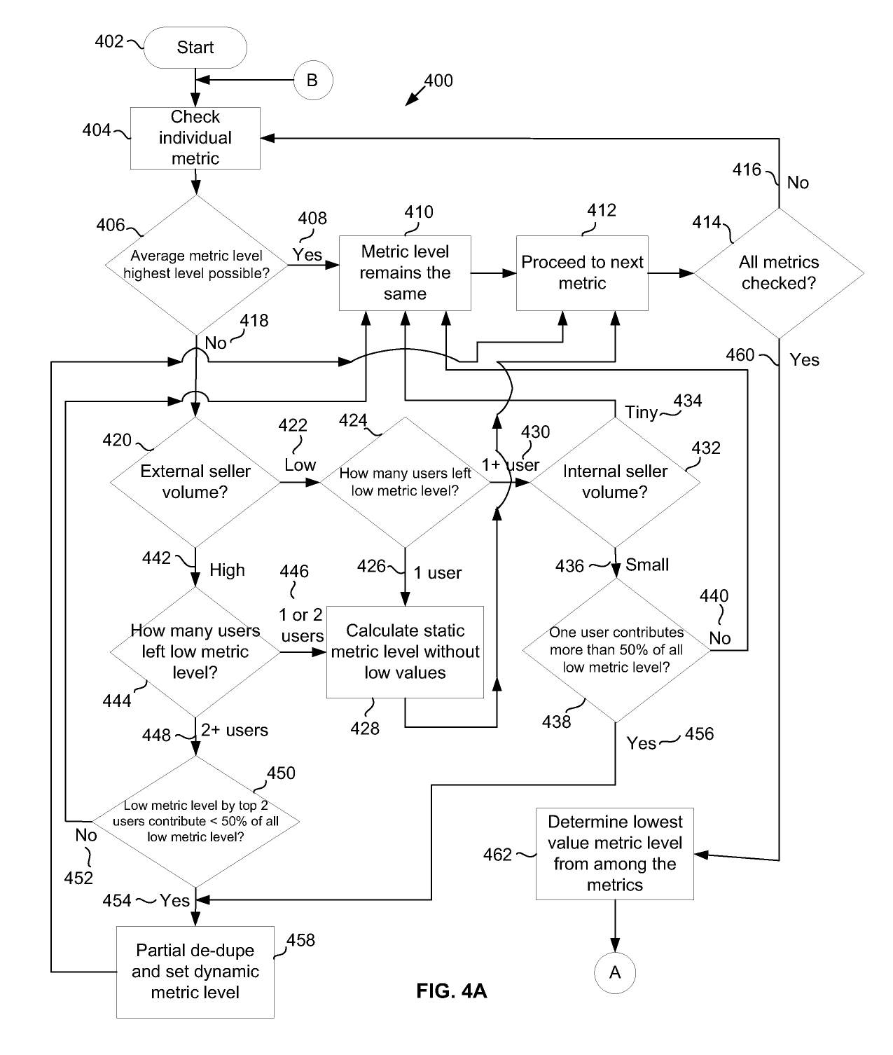

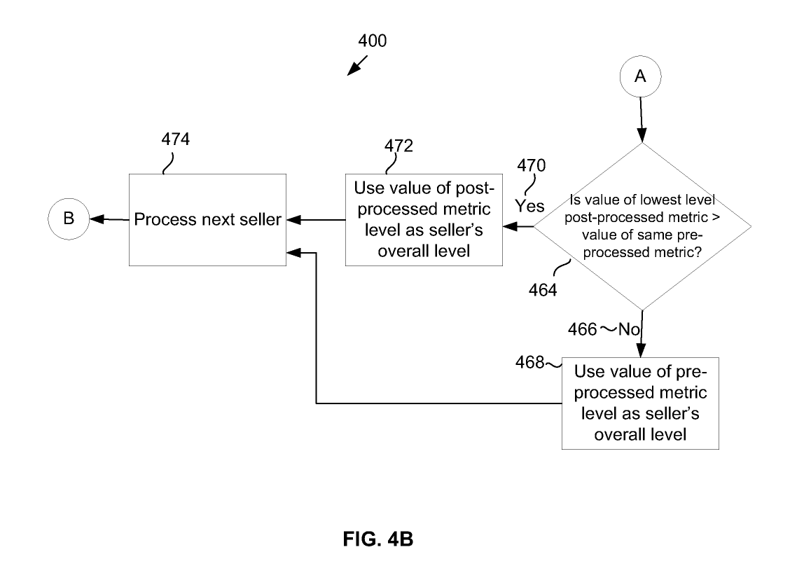

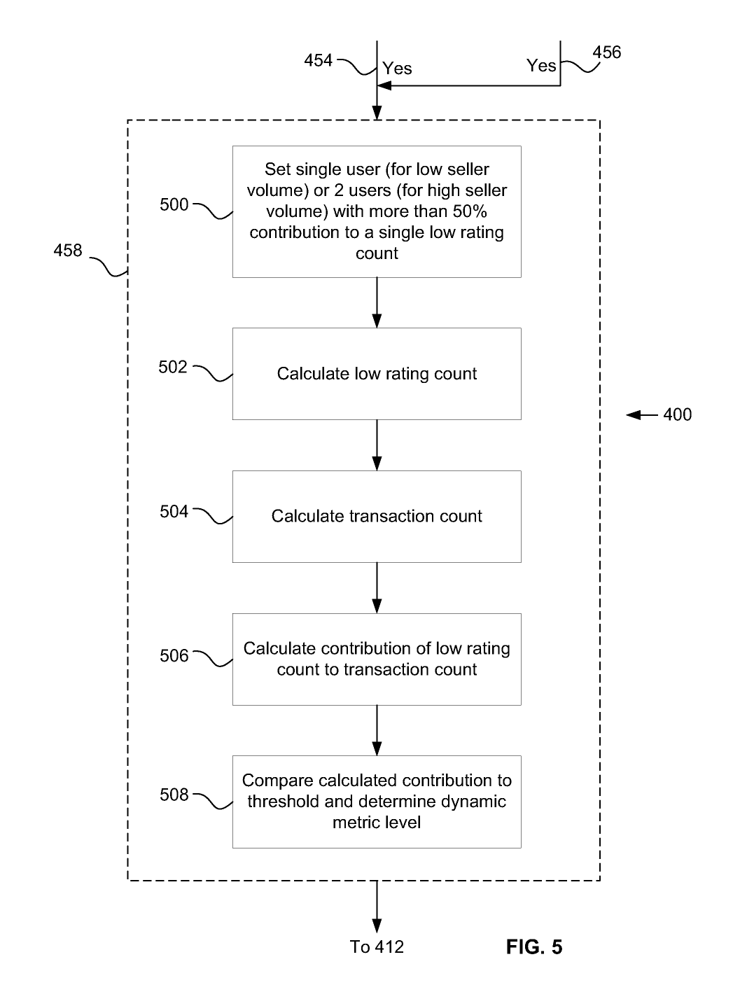

FIGS. 4A-5 illustrate a flow diagram 400 for generating fairness based ratings according to some embodiments. The rating adjustment module 306 of the reputation applications 208 is configured to perform the process illustrated in flow diagram 400. Flow diagram 400 can be applied for every user (e.g., seller) for whom a composite rating will be presented to other users. For each user, ratings of that user are evaluated and a composite rating from a plurality of users is calculated in accordance with flow diagram 400.

For a given ratee, the generation of a composite rating for a given metric starts at a start block 402. For a first metric (e.g., how well a seller's item was described to buyers), ratings from a plurality of raters associated with the first metric for the ratee are retrieved (block 404). The retrieved ratings can be those classified and stored by the rating identification module 304. A check is performed as to the average value of the retrieved ratings (block 406). If the average value of those ratings is the highest level possible (yes branch 408), then the composite rating value for the first metric for that ratee (also referred to as the metric level) is the highest value possible (block 410). In other words, the metric level remains the same as the average rating value. For example, if all the buyers submitted a rating of 5 out of a possible range of 1 to 5, with 5 being the highest value possible, for the first metric for a seller, the seller has uniformly received the highest rating value possible from every buyer that purchased a particular item from the seller. There is no need to adjust the average rating value or otherwise factor in a fairness value since the average rating value cannot be increased any higher.

Next, the process proceeds to evaluate the next metric (block 412). If all the metrics for the ratee have been checked (block 414, yes branch 460), then the process proceeds to block 462. Otherwise (no branch 416), the next metric for the ratee is evaluated by returning to block 404. Continuing the example above, the second metric may be how well the seller communicated with the buyer regarding the purchase.

In block 406, if the average rating value for the first metric is not the highest value possible (no branch 418), then an external ratee volume is checked (block 420). The external ratee volume is a number of transactions pertaining to the ratee within a specified time period. For example, the external ratee volume may be a number of transactions associated with a seller, such as a number of purchase orders attributable to the seller within the past four months. The external ratee volume may also be referred to as an external seller volume, seller volume, or volume seller. Such volume information may be tracked (and stored) by the rating identification module 304 and obtained by the rating adjustment module 306 from a database.

In one embodiment, a “high” external ratee volume may be deemed to be more than or equal to 400 transactions within the last 12 months, and a “low” external ratee volume may be less than 400 transactions within the last 12 months. Alternatively, the pre-determined value separating the high and low volumes may be set to a number less or more than 400 transactions, and the specified time period may also be set to less or more than 12 months. At block 420, if the ratee is designated to have a “low” external volume (e.g., less than 400 transactions attributable to the ratee) (low branch 422), then the number of raters that submitted low ratings for the current metric for the ratee are counted (block 424). Low ratings can comprise the lowest possible rating (e.g., a rating value of 1 out of a range of 1 to 5), the lowest and the next lowest possible ratings (e.g., rating values of 1 and 2 out of a range of 1 to 5), or some other pre-determined designation of rating values deemed to be within a low category. Similar to the other rating and volume information discussed above, the low ratings for the current metric and associated data such as unique identification of the raters are indexed and stored by the rating identification module 304 and subsequently retrieved by the rating adjustment module 306 from a database.

When there is just one rater or user that submits low ratings for the current metric for the ratee (1 user branch 426), then those ratings associated with the one rater are discarded for purposes of calculating the composite rating for the current metric for the ratee (block 428). The composite rating, also referred to as a static metric level, comprises an average of the remaining rating values. For example, a single buyer may have given a seller one or more low ratings while all the other buyers gave the same seller higher ratings. In the case where the number of transactions associated with the seller is low, the single buyer's low rating(s) may disproportionately and/or unfairly affect the composite rating.

Once the static metric level has been generated in block 428, the process proceeds to block 412 to evaluate the next metric for the ratee.

On the other hand, if more than one rater or user submits low ratings for the current metric for the ratee (1+ user branch 430), then an internal ratee volume is checked (block 432). The internal ratee volume is similar to the external ratee volume in that it is also a number of transactions pertaining to the ratee within a specified time period. However, unlike the external ratee volume, the internal ratee volume has different classifications. As an example, a ratee's transactions can be classified as follows:
“Large”—Greater than or equal to 400 transactions within the last three months,
“Medium”—Less than 400 transactions within the last three months, and greater than or equal to 400 transactions within the last 12 months,
“Small”—Less than 400 transactions within the last 12 months, and greater than or equal to 100 transactions within the last 12 months, or
“Tiny”—Less than 100 transactions within the last 12 months.

Alternatively, the classification designations may use a different number of transactions and/or different specified time periods than discussed above. The internal ratee volume may also be referred to as an internal seller volume, seller volume, or volume seller. Such volume information may be tracked (and stored) by the rating identification module 304 and obtained by the rating adjustment module 306 from a database.

In one embodiment, both the internal and external volume classifications are implemented to facilitate anti-fraud measures—namely, to make certain business decisions or treatment of ratings opaque to disincentivize gaming the system. In another embodiment, internal and external volume classifications can be collapsed into one set of classifications to classify the ratee volume once rather than twice. For example, block 432 classifying the ratee volume as a “tiny” or “small” ratee volume may be omitted, and the 1+ user branch 430 may connect to block 440. Effectively low external ratee volume encompasses the small and tiny internal ratee volumes and the high external ratee volume encompasses the large and medium internal ratee volumes.

For a ratee designated as having a “low” external ratee volume, his or her internal volume may be designated as “tiny” or “small.” In the case of a “tiny” internal volume (tiny branch 434), the composite rating value remains the same as the average rating value (block 410). The low ratings are included in the composite rating value because, unlike in the case of only a single rater giving the ratee the low rating(s) (as with the 1 user branch 426 and block 428), more than one rater submitted at least one low rating on the same metric for the same ratee. Consequently, there is less of a chance that the low rating(s) are outliers. Note that as discussed above, low ratings can comprise the lowest possible rating (e.g., a rating value of 1 out of a range of 1 to 5), the lowest and the next lowest possible ratings (e.g., rating values of 1 and 2 out of a range of 1 to 5), or some other pre-determined designation of rating values deemed to be within the low category.

For a ratee designated as having a “low” external ratee volume and a “small” internal ratee volume (small branch 436), a low volume ratee 50% rule check is applied (block 438). In one embodiment, the 50% rule check comprises evaluating whether a single rater has contributed more than 50% of all the low ratings for a given metric for a ratee. If the single rater's contribution is less than 50% (no branch 440), then the composite rating is the average of all the ratings for that metric (block 410). Otherwise (yes branch 456), the composite rating is calculated from partial de-duping in block 458.

An example application of the 50% rule check is discussed below. Assume three buyers submitted low ratings for a given metric for a low volume seller: Buyer A submitted 10 low ratings, Buyer B submitted 20 low ratings, and Buyer C submitted 5 low ratings. The total low ratings count is thus 35 (10+20+5). The buyer that submitted the most number of low ratings, which in this example is Buyer B with 20 low ratings is identified. Next, the percentage contribution of Buyer B's number of low ratings to the total number of low ratings is calculated:

(Buyer B's 20 low ratings/Total of 35 low ratings)×100%=57%

Since Buyer B's contribution of low ratings at 57% is more than 50%, the composite rating for the metric for the seller requires partial de-duping in block 458.

In alternate embodiments, the threshold for adjusting the contribution of low ratings to the composite rating (e.g., performing partial de-duping) or merely including the low ratings to generate the composite rating may be set to a value other than 50%. For example, the threshold value may be set to a value greater than 50%, such as 55 or 60%, or to a value less than 50%, such as 40 or 45%. The threshold value may be a balance between various factors such as pure objectivity, favorable treatment of ratees, fraud detection pertaining to ratings submissions, and the like.

Returning to block 420, when the external ratee volume is deemed to be “high” (high branch 442), then the number of raters that submitted low ratings for the current metric for the ratee are counted (block 444). Low ratings can comprise the lowest possible rating (e.g., a rating value of 1 out of a range of 1 to 5), the lowest and the next lowest possible ratings (e.g., rating values of 1 and 2 out of a range of 1 to 5), or some other pre-determined designation of rating values deemed to be within the low category. Similar to the other rating and volume information discussed above, the low ratings for the current metric and associated data such as unique identification of the raters are indexed and stored by the rating identification module 304 and subsequently retrieved by the rating adjustment module 306 from a database.

When only one or two raters have submitted low ratings (1 or 2 users branch 446), those low ratings are excluded for purposes of calculating the composite rating (block 428). Those ratings may be considered to be outliers. On the other hand, if more than two raters have submitted low ratings (2+ users branch 448), a high volume ratee 50% rule check is applied (block 450). In one embodiment, this 50% rule check comprises evaluating whether two raters combined have contributed more than 50% of all the low ratings for a given metric for a ratee. If the contribution is less than 50% (no branch 452), then the composite rating is the average of all the ratings for that metric (block 410). Otherwise (yes branch 454) the composite rating is calculated from partial de-duping in block 458.

The high volume ratee 50% rule check is similar to the low volume ratee 50% rule check except the contributions of two raters are considered instead of a single rater. An example application of the high volume ratee 50% rule check is described below. Assume four buyers submitted low ratings for a given metric for a high volume seller: Buyer A submitted 100 low ratings, Buyer B submitted 200 low ratings, Buyer C submitted 10 low ratings, and Buyer D submitted 10 low ratings. The total low ratings count is thus 320 (100+200+10+10). The two buyers that submitted the most number of low ratings are identified, which in this example are Buyers A and B with respectively 100 and 200 low ratings. Next, the percentage contribution of Buyers A and B's number of low ratings to the total number of low ratings is calculated:

((Buyer A's 100 low ratings+Buyer B's 200 low ratings)/Total of 320 low ratings)×100%=94%

Since Buyers A and B's contributions of low ratings at 94% is more than 50%, the composite rating for the metric for the seller requires partial de-duping in block 458.

In alternate embodiments, the threshold for adjusting the contribution of low ratings to the composite rating (e.g., performing partial de-duping) or merely including the low ratings to generate the composite rating may be set to a value other than 50%. For example, the threshold value may be set to a value greater than 50%, such as 55 or 60%, or to a value less than 50%, such as 40 or 45%. The threshold value may be a balance between various factors such as pure objectivity, favorable treatment of ratees, fraud detection pertaining to ratings submissions, and the like.

At block 458, contribution of the high number of low ratings for a given metric for a given ratee is adjusted. The resulting value comprises a composite rating or metric level, and may also be referred to as a dynamic composite rating or dynamic metric level. In flow diagram 400, two pathways lead to block 458: a low ratee volume pathway including blocks 424, 432, and 438, and a high ratee volume pathway including blocks 444 and 448. Both pathways involve determining which raters are responsible for low ratings and calculating the contribution of those ratings to all ratings, albeit in slightly different ways depending on the ratee's volume. The different pathways dictated by different ratee volumes may be considered to be processing according to pre-determined profiles for the respective ratee's volumes.

FIG. 5 illustrates a detailed flow diagram of block 458 according to some embodiments and will be described in conjunction with the above example of a high volume seller with low ratings from Buyers A, B, C, and D.

At a block 500, the number (also referred to as a count) of low ratings from the single rater (in the case of a low ratee volume) or the two raters (in the case of the high ratee volume) responsible for more than a 50% contribution of all the low ratings is reduced to a single count. Recall that the single rater responsible for more than a 50% contribution for the low ratee volume was identified in block 438, and the two raters responsible for more than a 50% contribution for the high ratee volume were identified in block 450. In the case of the low ratee volume, regardless of how many low ratings were submitted by the single rater for the current metric for the ratee, the number of low ratings is set to one. Similarly, in the case of the high ratee volume, regardless of how many low rating were submitted by each of the two raters for the current metric for the ratee, the number of low ratings is set to one for each of these two raters. Setting the count to one is also referred to as partial de-duping.

Continuing the above example of the high volume seller with low ratings from Buyers A, B, C, and D, Buyers A and B are the two buyers with the highest number of low ratings—Buyer A with 100 low ratings and Buyer B with 200 low ratings. At block 500, the low rating count for each of Buyers A and B are set to one. The remaining Buyers C and D with 10 low ratings each, remain the same.

Next a total low rating count for the current metric for the ratee is calculated (block 502). Continuing the above example, the total low rating count is 22 (1+1+10+10).

At a block 504, a transaction count for the current metric for the ratee is calculated. Continuing the above example, assume that the seller has a total of 1000 transactions, which includes transactions with Buyers A, B, C, and D that resulted in the low ratings. Typically one rating is submitted per transaction for a given metric. The transaction count totals 702 (1000 actual transactions−Buyer A's 100 actual transactions−Buyer B's 200 actual transactions+Buyer A's 1 partial de-duped transaction+Buyer B's 1 partial de-duped transaction).

Next at a block 506, the contribution of the low ratings count to the transaction count is calculated. Continuing the above example, the contribution percentage is (22/702)×100%=3.13%.

Once the contribution percentage is determined, it is compared against pre-determined threshold value(s) to determine a dynamic metric level (block 508). In one embodiment, the threshold values may be as follows:

| Low rating contribution | |
|---|---|
| percentage | Metric level |
| <=0.5% | Top rating |
| >0.5% and <=2% | Above standard rating |
| >2% and <=4% | Standard rating |
| >4% | Below standard rating |

In the above example, the low rating contribution of 3.13% (which is >2% and <=4% in the table above) corresponds to a Standard rating level. Without partial de-dupe of the low ratings in the above example, the low rating contribution would be 32% ((100+200+10+10) total low ratings count/1000 low rating transactions), which corresponds to a Below standard rating level (32% is >4% threshold). Thus, by dynamically taking into account the low rating contributions, in particular the “unfair” impact of low ratings from a very small number of raters, the resulting (new) metric level is favorable to the ratee.

Upon determining the dynamic metric level at block 458, the process proceeds to evaluate the next metric for the ratee (block 412).

Once each of the individual metric levels for a ratee—also referred to as post-processed metric levels—have been evaluated and adjusted, as needed (yes branch 460), a composite metric level for the ratee can be determined. The composite metric level for the ratee is also referred to as a ratee performance, ratee performance level, seller performance, or seller performance level. At a block 462, the lowest metric level from among the ratee's individual metric levels is identified. Next, this identified post-processed metric level is compared against an average metric level (also referred to as a pre-processed metric level) for the same metric (block 464). If the post-processed metric level is less than or equal to the pre-processed metric level (no branch 466), then use the pre-processed metric level as the composite metric level for the ratee (block 468). Otherwise, the post-processed metric level is greater than the pre-processed metric level (yes branch 470) and the post-processed metric level should be the composite level for the ratee (block 472). Once the composite metric or performance level for the ratee has been determined, flow diagram 400 repeats for the next ratee (block 474).

As an example, pre-processed metric levels for a seller is shown below, in which the metric or performance level for each individual metric is a mathematical average of ratings for the respective metric from all the buyers about the seller.

| | Pre-Processed Performance |
|---|---|
| Metrics | Levels |
| Item as described | Standard |
| Communication | Above standard |
| Ship time | Above standard |
| Ship cost | Above standard |
| Opened cases | Standard |
| Closed cases without seller | Below standard |
| resolution | |

The composite metric or performance level for the seller may be the lowest metric level value from among the seller's individual metric level values—“Below standard.” Thus, the seller may be deemed to be a below standard seller. This “below standard” rating may be displayed for prospective buyers and others.

However, upon implementation of fairness based ratings, the seller's ratings for each individual metrics are evaluated and adjusted in accordance with FIGS. 4-5 to generate a set of post-processed metric or performance levels.

| | Pre-Processed | Post-Processed |
|---|---|---|
| Metrics | Performance Levels | Performance Levels |
| Item as described | Standard | Standard |
| Communication | Above standard | Above standard |
| Ship time | Above standard | Above standard |
| Ship cost | Above standard | Above standard |
| Opened cases | Standard | Above Standard |
| Closed cases without seller | Below standard | Standard |
| resolution | | |

In the table above, the post-processed performance levels for each of the “Opened cases” and “Closed cases without seller resolution” metrics have been positively impacted relative to the corresponding pre-processed values. The lowest post-processed performance level is now “Standard,” which is greater than the corresponding “Below standard” pre-processed value. Accordingly, the seller is now deemed to be a standard seller. And this “Standard” designation will be displayed for prospective buyers and others rather than the “Below standard” designation. (Excessive) negative evaluations of the seller are identified and taken into account, resulting in a more “fair” overall rating of the seller.

Although FIGS. 4-5 show sequential evaluation of each metric level, it is understood that they may be evaluated simultaneously. FIGS. 4-5 also show sequential evaluation of each ratee's metric levels. Similarly, more than one ratee's metric levels may be evaluated at the same time. When average or pre-processed metric or performance levels are used, these may be pre-determined and stored prior to implementing flow diagram 400. Alternatively, these may be calculated on an as-needed basis. The process illustrated in FIGS. 4-5 is periodically repeated so that the overall rating associated with each ratee reflects newly submitted ratings. For example, the overall rating may be updated, but is not limited to, daily, weekly, monthly, quarterly, three times a year, twice a year, and the like. The frequency at which the overall rating for each ratee is recalculated depends on factors such as the number of ratings, number of ratees, capacity of the processing equipment, priority in keeping the overall ratings up-to-date, and the like.

The example embodiments illustrated in FIGS. 4-5 addresses the impact of low or negative ratings for each metric, thereby causing the overall rating for a ratee to be at least the same or higher than it otherwise would be. In an alternate embodiment, the fairness based ratings mechanism can be implemented to suppress high or positive ratings for each metric, thereby causing the overall rating for a ratee to be at least the same or lower than it otherwise would be. The rating adjustment module 306 can be modified to evaluate the high ratings (e.g., the highest rating, or the highest and the next highest ratings) for each metric for a ratee instead of the low ratings in FIGS. 4-5. In another alternate embodiment, both the low and high ratings can be evaluated to adjust for both extreme ends of the ratings spectrum. In still another alternate embodiment, one or more select metrics of the set of metrics for a ratee can be evaluated for fairness rather than all the metrics for the ratee. This may be advantageous if a certain metric is more important for rating purposes than the other metrics.

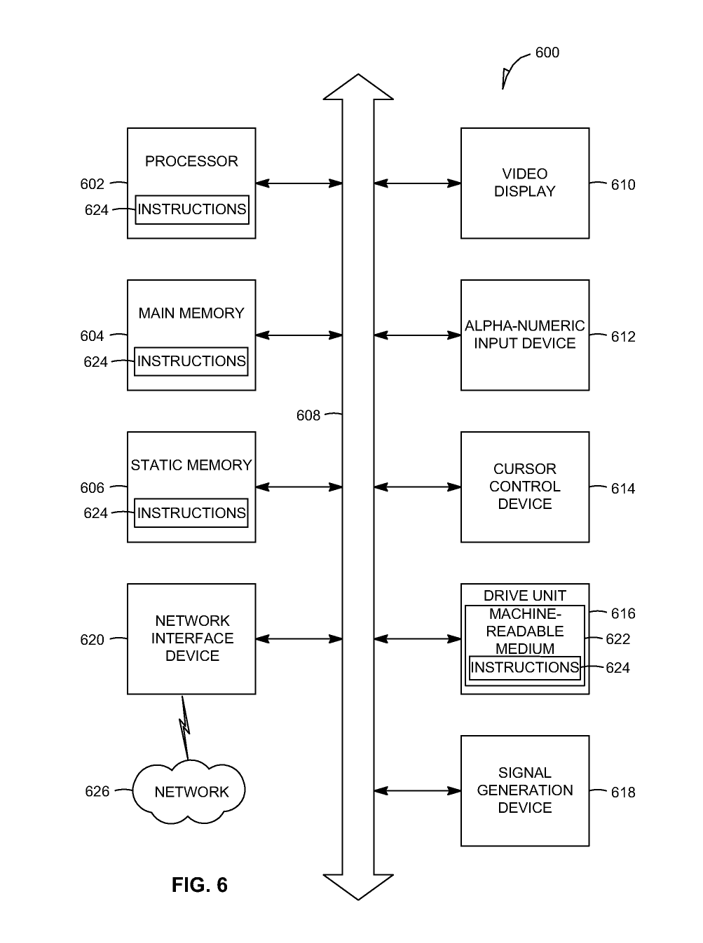

FIG. 6 shows a diagrammatic representation of a machine in the example form of a computer system 600 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 600 includes a processor 602 (e.g., a central processing unit (CPU), a graphics processing unit (GPU), or both), a main memory 604 and a static memory 606, which communicate with each other via a bus 608. The computer system 600 may further include a video display unit 610 (e.g., liquid crystal display (LCD) or a cathode ray tube (CRT)). The computer system 600 also includes an alphanumeric input device 612 (e.g., a keyboard), a cursor control device 614 (e.g., a mouse), a disk drive unit 616, a signal generation device 618 (e.g., a speaker) and a network interface device 620.

The disk drive unit 616 includes a machine-readable medium 622 on which is stored one or more sets of instructions (e.g., software 624) embodying any one or more of the methodologies or functions described herein. The software 624 may also reside, completely or at least partially, within the main memory 604 and/or within the processor 602 during execution thereof by the computer system 600, the main memory 604 and the processor 602 also constituting machine-readable media.

The software 624 may further be transmitted or received over a network 626 via the network interface device 620.

While the machine-readable medium 622 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

Thus, a method and system to evaluate ratings of ratees on each of a plurality of metrics for disproportionate impact on composite ratings and dynamically configuring the composite ratings to minimize the ratings having undesirable disproportionate impact have been described. Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method for generating a composite rating about a first user, the method comprising:
receiving a plurality of ratings about the first user from a plurality of second users, each of the ratings associated with a transaction between the first user and one of the second users;
classifying, using at least one processor, the first user based on a number of the transactions;
determining the second users that submitted the ratings from the received plurality of ratings that satisfy a pre-determined profile, the pre-determined profile is in accordance with the classification of the first user;
adjusting the ratings from at least one of the second users that satisfy the pre-determined profile and which exceed a threshold; and
generating the composite rating about the first user using the adjusted ratings and remaining ratings from the received plurality of ratings.

2. The method of claim 1, wherein the first user comprises a seller and the second users comprise buyers.

3. The method of claim 1, wherein classifying the first user comprises classifying the first user as a high volume ratee or a low volume ratee.

4. The method of claim 3, wherein the first user is a low volume ratee and the pre-determined profile comprises one of the second user contributing more than 50% of the ratings that match a specific rating from among all ratings in the received plurality of ratings that match the specific rating.

5. The method of claim 3, wherein the first user is a high volume ratee and the pre-determined profile comprises more than one of the second users combined contributing more than 50% of the ratings that match a specific rating from among all ratings in the received plurality of ratings that match the specific rating.

6. The method of claim 1, wherein determining the second user comprises identifying at least one of the second users that submitted the ratings that match a specific rating.

7. The method of claim 6, wherein the specific rating comprises a lowest value rating from a ratings scale of the ratings.

8. The method of claim 6, wherein the specific rating comprises a highest value rating from a ratings scale of the ratings.

9. The method of claim 1, wherein the plurality of ratings comprise the ratings for a first metric pertaining to the transactions.

10. The method of claim 9, further comprising:
receiving a plurality of second ratings about the first user from a plurality of second users, wherein each of the second ratings is associated with a second metric of the transactions between the first user and one of the second users, the first metric and the second metric being different from each other;
adjusting the second ratings from at least one of the second users that satisfy the pre-determined profile and which exceed the threshold; and
generating a second composite rating about the first user using the adjusted second ratings and the remaining second ratings.

11. The method of claim 10, further comprising:
selecting between the composite rating and the second composite rating for an overall composite rating about the first user.

12. The method of claim 11, further comprising:
setting an average of the plurality of ratings for the first metric as the overall composite rating when the composite rating is selected over the second composite rating and the composite rating is less than the average of the plurality of ratings for the first metric.

13. A non-transitory computer readable medium including instructions, when executed by a processor, causes the processor to perform operations comprising:
calculating a contribution amount of specific ratings from a second user to all ratings from a plurality of second users, wherein the ratings from the plurality of the second users pertain to a performance metric of a first user and the specific ratings are ratings having a particular value from a ratings scale;
in response to the contribution amount exceeding a threshold value, changing a count of the specific ratings from the second user to an another count; and
calculating a composite rating for the performance metric of the first user based on the another count of the specific ratings and the ratings of the remaining second users.

14. The computer readable medium of claim 13, wherein the specific ratings is at least a lowest ratings value from the ratings scale.

15. The computer readable medium of claim 13, wherein the specific ratings is at least a highest ratings value from the ratings scale.

16. The computer readable medium of claim 13, wherein the another count is a single count.

17. The computer readable medium of claim 13, further comprising classifying the first user as a low volume user or a high volume user based on a transaction count.

18. The computer readable medium of claim 17, wherein the first user is a high volume user, and the calculating of the contribution amount comprises calculating the contribution amount of the specific ratings from more than one of the second users with the highest counts of the specific ratings.

19. The computer readable medium of claim 13, wherein the ratings comprises at least one of a feedback, an evaluation, a review, an opinion, a testimonial, or a commentary.

20. A system, comprising:
a storage device including a plurality of feedbacks about a first user from a plurality of second users, each of the feedback associated with a transaction between the first user and the one of the second users; and
a computing device in communication with the storage device and configured to:
classify the first user based on a number of the transactions,
determine the second users that submitted the feedbacks that satisfy a pre-determined profile, the pre-determined profile being in accordance with a classification of the first user,
adjust the feedbacks from at least one of the second users that satisfy the pre-determined profile and which exceed a threshold, and
generate a composite feedback about the first user using the adjusted feedbacks and remaining ratings in the storage device.

21. The system of claim 20, wherein the computing device is configured to adjust the feedbacks to a single count of feedback.

22. The system of claim 20, wherein the pre-determined value comprises a negative feedback value.

23. The system of claim 20, wherein the pre-determined value comprises a positive feedback value.

24. The system of claim 20, wherein the threshold is 50%.
